(19) United States
(12) Patent Application Publication
(10) Pub. No.: US 2013/0003779 A1
(43) Pub. Date: Jan. 3, 2013

(54) WIRELESS MEASURING APPARATUS AND WIRELESS TEMPERATURE MEASUREMENT SYSTEM

(75) Inventors: Tsuguo Fukuda, Miyagi (JP); Mitsuru Sato, Miyagi (JP); Junichi Kojima, Tokyo (JP); Yukinaga Koike, Nagano (JP)

(73) Assignee: FURUYA METAL CO., LTD., Tokyo (JP)

(21) Appl. No.: 13/518,194

(22) PCT Filed: Dec. 24, 2010
(86) PCT No.: PCT/JP2010/073413

§ 371 Date: Aug. 28, 2012

(30) Foreign Application Priority Data
Dec. 28, 2009 (JP) 2009-298308

(51) Int. Cl. G01K 11/22; G01H 13/00

(52) U.S. Cl. 374/117; 73/579; 374/E11.011

(57) ABSTRACT

There is provided a wireless measuring apparatus that efficiently measures the frequency characteristics of a sensor unit mounted on an object to be measured. The wireless measuring apparatus is a wireless measuring apparatus that measures the frequency characteristics of a sensor unit (10) mounted on an object (40) to be measured, including the sensor unit (10) having a piezo-resonator (11), an antenna (20) that forms a circuitry with the sensor unit (10), and a measuring element (30) that supplies high frequency electricity changed in different frequency to the circuitry and measures the frequency characteristics of the reflected electricity strength received from the circuitry.

### TECHNICAL FIELD

The present invention relates to a wireless measuring apparatus using an electrically resonant element such as a piezoelectric vibrator.

### BACKGROUND ART

Conventionally, there is a wireless temperature measuring apparatus using a quartz crystal unit that the resonance frequency of the quartz crystal unit is greatly changed with respect to temperature for a piezo-resonator, in which an element having a coil connected to the quartz crystal unit in parallel is used for a temperature sensor unit. In this apparatus, the temperature sensor unit receives electromagnetic waves intermittently emitted from the transmission side. In the case where the frequency of the electromagnetic waves is matched with the oscillation frequency of the temperature sensor unit, the frequency becomes a resonance frequency, and the temperature sensor unit emits electromagnetic waves at the resonance frequency as damped oscillatory waves. The wireless temperature measuring apparatus receives the emitted damped oscillatory waves, and converts the frequency into temperature to measure a temperature (Non-Patent document 1, for example).

Moreover, there are an article detecting apparatus and a wireless tag identification system that an LC resonant circuit is used as a tag and damped oscillatory waves emitted from the resonant circuit are used (Patent Document 1 and Patent Document 2, for example).

### PRIOR ART DOCUMENT

### Patent Documents

Patent Document 1: JP-T-2001-134729

Patent Document 2: JP-A-2009-205448

### Non-Patent Document

Non-Patent document 1: “Echo Crystal Thermometer”

Catalog published by TOKYO DENPA CO., LTD

### SUMMARY OF THE INVENTION

### Problems to be Resolved by the Invention

However, in Non-Patent document 1 or in Patent documents 1 and 2, a problem arose in that in the case where damped oscillatory waves from the temperature sensor (or the tag) are received to obtain information such as temperature from the frequency of the damped oscillatory waves, the intensities of transmitting electromagnetic waves and the damped oscillatory waves from the temperature sensor (or the tag) are greatly changed depending on an environment in which a transmission and reception antenna is disposed, and damped oscillatory waves with intensity necessary and sufficient for measurement are not obtained.

Therefore, the present invention is made to focus attention on this problem. It is an object of the present invention to provide a wireless measuring apparatus with a wide application range that efficiently detects the resonance frequency of a sensor unit including a resonant circuit under a severe electromagnetic environment.

### Means of Solving the Problems

A wireless measuring apparatus according to the present invention is a wireless measuring apparatus that measures frequency characteristics of a sensor unit mounted on an object to be measured, the wireless measuring apparatus including: a sensor unit having a resonant circuit or a piezo-resonator; an antenna configured to form a circuitry with the sensor unit; and a measuring means configured to supply high frequency electricity changed in different frequency to the circuitry and measure frequency characteristics of reflected electricity strength received from the circuitry.

Moreover, in the wireless measuring apparatus according to the present invention, a serial resonant circuit is equivalently formed using the sensor unit and the antenna.

Furthermore, in the wireless measuring apparatus according to the present invention, the sensor unit has a circuit having a piezo-resonator connected to a coil in parallel.

In addition, in the wireless measuring apparatus according to the present invention, the sensor unit is a temperature sensor including a piezo-resonator that an oscillation frequency is changed depending on temperature; and the measuring means has a means configured to measure a resonance frequency from the oscillation frequency of the piezo-resonator changed depending on temperature and convert the resonance frequency into temperature to measure a temperature of an object to be measured.

A wireless temperature measurement system according to the present invention is a wireless measurement system that measures a temperature of an object to be measured using a sensor unit mounted on the object to be measured, the wireless measurement system including: a sensor unit having a piezo-resonator that an oscillation frequency is changed depending on temperature; an antenna configured to form a circuitry with the sensor unit; and a temperature measuring apparatus configured to supply high frequency electricity changed in different frequency to the circuitry, measure a resonance frequency from frequency characteristics of reflected electricity strength received from the circuitry, and convert the resonance frequency into temperature to measure a temperature of an object to be measured.

Moreover, in the wireless temperature measurement system according to the present invention, a serial resonant circuit is equivalently formed using the sensor unit and the antenna.

Furthermore, in the wireless temperature measurement system according to the present invention, the sensor unit has a circuit having a piezo-resonator connected to a coil in parallel.

A temperature measurement program according to the present invention is a temperature measurement program that operates a program control processor of a temperature measuring apparatus in which a sensor unit having a piezo-resonator that an oscillation frequency is changed depending on temperature is mounted on an object to be measured and an antenna configured to form a circuitry with the sensor unit is used to measure a temperature of the measured subject, the program causing the program control processor to function as a temperature measuring function including: supplying high frequency electricity changed in different frequency to the circuitry; measuring a resonance frequency from frequency characteristics of reflected electricity strength received from the circuitry; and converting the resonance frequency into temperature to measure a temperature of an object to be measured.

### Effect of the Invention

According to the present invention, it is possible that the frequency of high frequency electricity supplied to the circuitry is changed and a frequency (the resonance frequency of a sensor unit) when high frequency electricity is absorbed into the sensor unit is obtained from a high frequency source. Thus, it is possible to eliminate the necessity of detecting resonance damped oscillatory waves from the sensor unit and provide stable frequency measurement.

### BRIEF DESCRIPTION OF THE DRAWINGS

FIG. 1 is a pattern diagram illustrating an exemplary overall structure of a wireless measuring apparatus according to a first embodiment of the present invention;

FIG. 2 is a pattern diagram of a graph plotting the frequency characteristics of reflected electricity strength received by a measuring means of the wireless measuring apparatus according to the first embodiment of the present invention;

FIG. 3 is a pattern diagram illustrating an exemplary overall structure of a wireless measurement system according to a second embodiment of the present invention;

FIG. 4 is a block diagram illustrating an exemplary configuration of a temperature measuring apparatus for use in the wireless measurement system according to the second embodiment of the present invention; and

FIG. 5 is data that the frequency characteristics of reflected electricity strength received by the measuring means of the wireless measuring apparatus according to the first embodiment of the present invention are measured by experiments.

### ILLUSTRATING EMBODIMENT FOR CARRYING OUT THE INVENTION

In the following, an illustrating embodiment for carrying out the present invention will be described in detail with reference to the drawings. It is noted that the present invention is not limited to embodiments described below.

### 1. First Embodiment

(1) Configuration of Wireless Measuring Apparatus

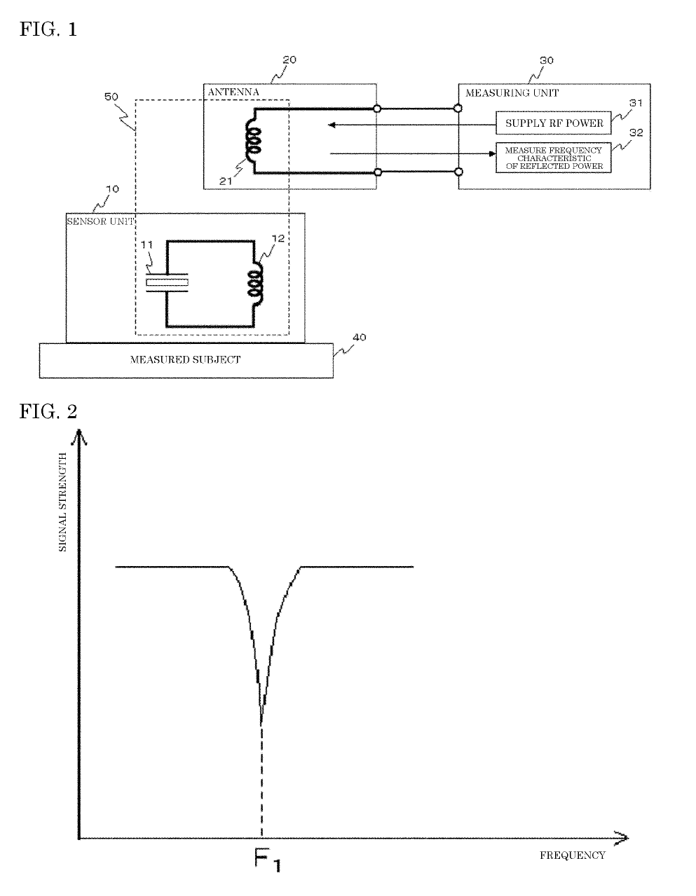

FIG. 1 is a pattern diagram illustrating an exemplary overall structure of a wireless measuring apparatus according to a first embodiment of the present invention. As illustrated in FIG. 1, the wireless measuring apparatus is a wireless measuring apparatus that measures the frequency characteristics of a sensor unit 10 mounted on an object 40 to be measured, in a configuration to include the sensor unit 10 having a piezo-resonator 11, an antenna 20 that forms a circuitry with the sensor unit 10, and a measuring means 30 that supplies high frequency electricity changed in different frequency to the circuitry and measures the frequency characteristics of the reflected electricity strength received from the circuitry.

Moreover, the wireless measuring apparatus equivalently forms a serial resonant circuit 50 using the sensor unit 10 and the antenna 20.

The measuring means 30 supplies high frequency electricity to the serial resonant circuit 50 (31). When high frequency electricity is supplied from the antenna 20, the measuring means 30 can resonate the resonant circuit of the sensor unit 10 by electromagnetic induction in a non-contact state. When resonance occurs in the sensor unit 10, resonance occurs in the serial resonant circuit 50, and the measuring means 30 receives the reflected electricity of the serial resonant circuit 50 through a coil 21 to measure the frequency characteristics of reflected electricity strength (32). Here, it is necessary to provide circuit design in which reflected waves are always returned from the antenna 20 to the measuring means 30.

When resonance occurs in the serial resonant circuit 50, the reflected electricity strength of the resonance frequency of the serial resonant circuit 50 is reduced, so that the wireless measuring apparatus can obtain the resonance frequency of the sensor unit 10 from the frequency characteristics of reflected electricity strength.

Moreover, the sensor unit 10 has a circuit that the piezo-resonator 11 is connected to the coil 12 in parallel as an example.

For example, the piezo-resonator 11 has characteristics that the oscillation frequency is changed depending on temperature. The sensor unit 10 can be used as a temperature sensor using the characteristics.

In this case, the measuring means 30 measures a resonance frequency from the oscillation frequency of the piezo-resonator 11 that is changed depending on temperature, and converts the resonance frequency into temperature, whereby the measuring means 30 can measure the temperature of the object 40 to be measured.

Moreover, in the description above, the case is described where a single piezo-resonator (a sensor unit) is used in the wireless measuring apparatus. However, the temperature at a plurality of locations on the object to be measured can be measured by disposing a plurality of piezo-resonators (sensor units) with different resonance frequencies from each other at a plurality of locations on the object to be measured.

From the description above, the wireless measuring apparatus according to the present invention is unnecessary to detect resonance damped oscillatory waves from the sensor unit, and the frequency characteristics of reflected electricity strength are measured to allow stable frequency measurement.

(2) Operation of Wireless Measuring Apparatus

Next, the operation of the wireless measuring apparatus to measure the temperature of the object to be measured will be described. Here, suppose that the piezo-resonator 11 has characteristics that the oscillation frequency is changed depending on temperature.

The measuring means 30 supplies high frequency electricity changed in different frequency to the serial resonant circuit 50 (31), and receives the reflected electricity of the serial resonant circuit 50 to measure the frequency characteristics of reflected electricity strength (32).

As illustrated in FIG. 2, since resonance occurs at a frequency F1 in the reflected electricity received by the measuring means 30, the signal strength of the reflected electricity is reduced. The measuring means 30 converts the resonance frequency F1 into temperature to measure the temperature of the object to be measured.

Moreover, in the case of measuring temperature at a plurality of locations on the object to be measured, temperature at a plurality of locations on the object to be measured can be measured by disposing a plurality of piezo-resonators (sensor units) with different resonance frequencies from each other at a plurality of locations on the object to be measured.

(3) Experimental Data

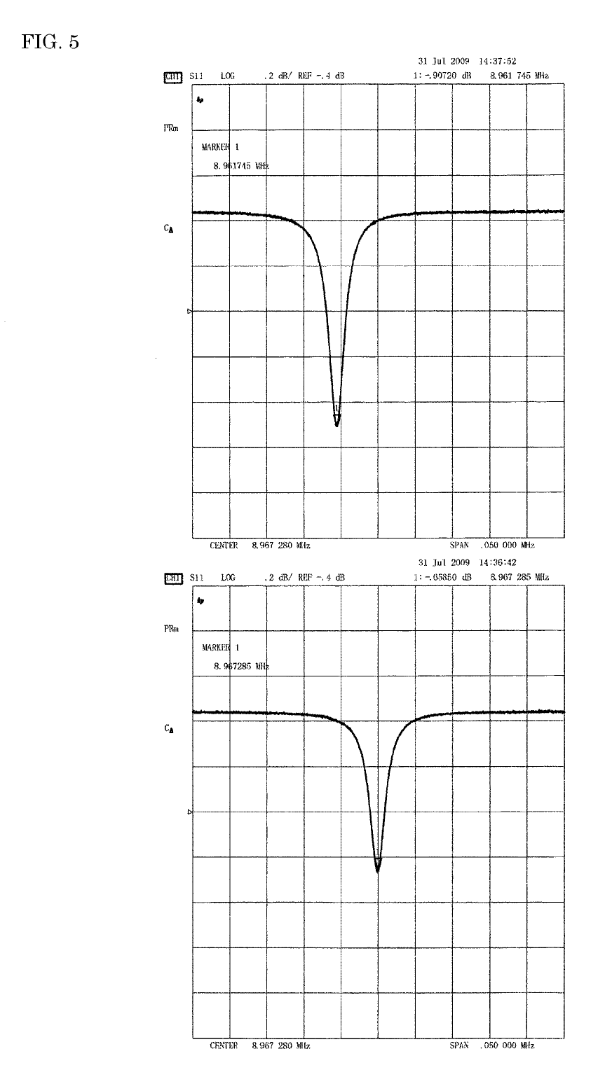

FIG. 5 illustrates data (LTGA dip characteristics), in which in the case of an LTGA temperature sensor using an LTGA resonator for a piezo-resonator, the wireless measuring apparatus measured the frequency characteristics of reflected electricity strength. An upper diagram in FIG. 5 illustrates that the resonance frequency is at 8.961745 MHz when the temperature of an object to be measured is at a predetermined temperature. It is noted that a scale on the horizontal axis is 5 kHz. Subsequently, a lower diagram in FIG. 5 illustrates that the resonance frequency is at 8.967285 MHz when the temperature of the object to be measured is higher than a predetermined temperature. Namely, it is revealed from the experimental data that it is effective to measure the frequency characteristics of reflected electricity strength to convert the resonance frequency into temperature for measuring the temperature of the object to be measured.

### 2. Second Embodiment

(1) Configuration of Wireless Measurement System

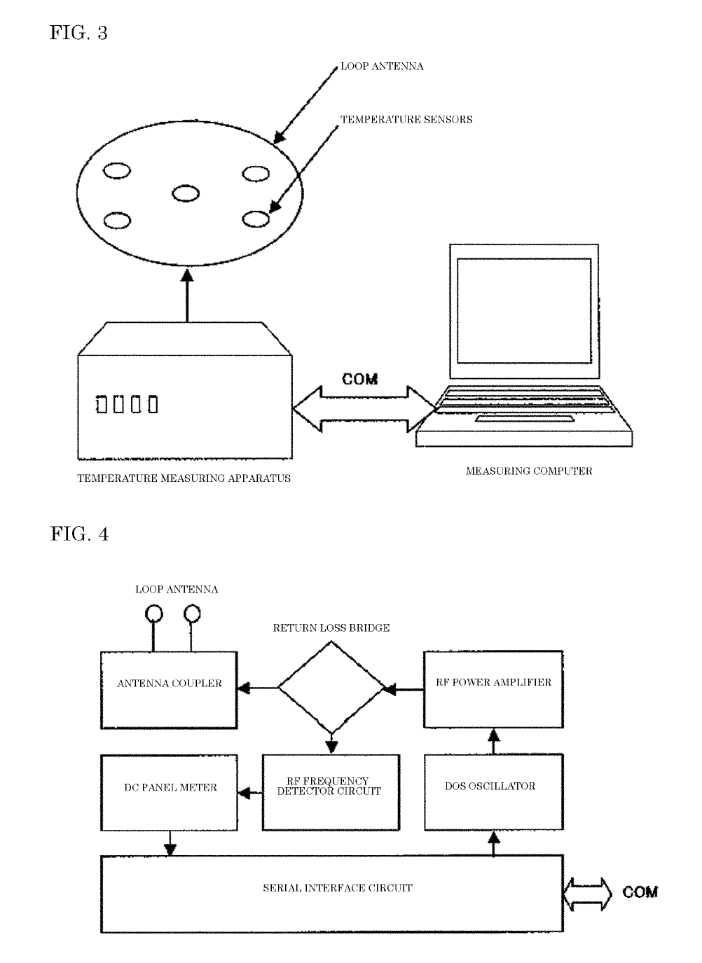

Next, a wireless measurement system using the wireless measuring apparatus explained above will be described. FIG. 3 is a pattern diagram illustrating an exemplary overall structure of a wireless measurement system according to a second embodiment of the present invention. As illustrated in FIG. 3, the wireless measurement system has temperature sensors, a loop antenna, a temperature measuring apparatus, and a measuring computer.

The temperature sensor has a piezo-resonator that the oscillation frequency is changed depending on temperature and a coil connected to the piezo-resonator in parallel, and a plurality of temperature sensors are disposed near the loop antenna.

The temperature sensors and the loop antenna form a circuitry, and a serial resonant circuit is equivalently formed at a certain frequency.

The temperature measuring apparatus supplies high frequency electricity changed in different frequency to the circuitry, measures a resonance frequency from the frequency characteristics of the reflected electricity strength received from the circuitry, and converts the resonance frequency into temperature to measure the temperature of the object to be measured.

The measuring computer is connected to the temperature measuring apparatus through a COM interface, instructs the temperature measuring apparatus, receives the result measured at the temperature measuring apparatus, and analyzes/displays the result.

Next, software installed in the measuring computer will be described. The temperature measuring apparatus is configured of functional blocks as illustrated in FIG. 4. The software of the measuring computer instructs the temperature measuring apparatus, receives the result measured at the temperature measuring apparatus, and analyzes/displays the result.

The software of the measuring computer outputs signals to a DDS (Direct Digital Synthesizer) oscillator through a serial interface circuit to sweep a DDS oscillation frequency, amplifies the DDS oscillation frequency to an appropriate output level at an RF electricity amplifier (High frequency electricity Amplifier), and adds the amplified frequency to a return loss bridge, and then high frequency electricity is supplied to the loop antenna.

Subsequently, reflected electricity from the circuitry formed of the temperature sensors (the temperature sensors using an LTGA resonator for a piezo-resonator, for example) installed on the loop antenna and the loop antenna is captured at the loop antenna and the return loss bridge. After detecting a high frequency at a high frequency detector circuit, the direct current voltage of the high frequency is converted into digital value data at a DC panel meter. The converted data is inputted as measurement data to the measuring computer through the serial interface circuit.

The software of the measuring computer receives measurement data from the temperature measuring apparatus, analyzes the measurement data, and displays the analyzed result. Moreover, the software of the measuring computer performs a linearizing operation in a state in which there is no temperature sensor, and flattens the frequency characteristics of a measurement system. The software of the measuring computer then receives measurement data (a frequency when reflected electricity is at the minimum), the software converts the frequency into temperature, and displays a temperature on a screen.

### INDUSTRIAL APPLICABILITY

The present invention is applicable to a wireless measuring apparatus that measures the temperature of an object to be measured.

### DESCRIPTION OF REFERENCE NUMERALS AND SIGNS

10 Sensor unit

11 Piezo-resonator

12 Coil

20 Antenna

21 Coil

30 Measuring means

40 Object to be measured

50 Resonant circuit

1. A wireless measuring apparatus that measures frequency characteristics of a sensor unit mounted on an object to be measured, the wireless measuring apparatus comprising:
a sensor unit having a resonant circuit or a piezo-resonator;
an antenna configured to form a circuitry with the sensor unit; and
a measuring means configured to supply high frequency electricity changed in different frequency to the circuitry and measures frequency characteristics of reflected electricity strength received from the circuitry.

2. The wireless measuring apparatus according to claim 1,
wherein a serial resonant circuit is equivalently formed using the sensor unit and the antenna.

3. The wireless measuring apparatus according to claim 1,
wherein the sensor unit has a circuit having a piezo-resonator connected to a coil in parallel.

4. The wireless measuring apparatus according to claim 1, wherein:
the sensor unit is a temperature sensor including a piezo-resonator that an oscillation frequency is changed depending on temperature; and
the measuring means has a means configured to measure a resonance frequency from the oscillation frequency of the piezo-resonator changed depending on temperature and convert the resonance frequency into temperature to measure a temperature of an object to be measured.

5. A wireless measurement system that measures a temperature of an object to be measured using a sensor unit mounted on the object to be measured, the wireless measurement system comprising:
a sensor unit having a piezo-resonator that an oscillation frequency is changed depending on temperature;
an antenna configured to form a circuitry with the sensor unit; and
a temperature measuring apparatus configured to supply high frequency electricity changed in different frequency to the circuitry, measure a resonance frequency from frequency characteristics of reflected electricity strength received from the circuitry, and convert the resonance frequency into temperature to measure a temperature of an object to be measured.

6. The wireless measurement system according to claim 5,
wherein a serial resonant circuit is equivalently formed using the sensor unit and the antenna.

7. The wireless measurement system according to claim 5,
wherein the sensor unit has a circuit having a piezo-resonator connected to a coil in parallel.

8. A temperature measurement program that operates a program control processor of a temperature measuring apparatus in which a sensor unit having a piezo-resonator that an oscillation frequency is changed depending on temperature is mounted on an object to be measured and an antenna configured to form a circuitry with the sensor unit is used to measure a temperature of the object to be measured, the program causing the program control processor to function as a temperature measuring function comprising:
supplying high frequency electricity changed in different frequency to the circuitry;
measuring a resonance frequency from frequency characteristics of reflected electricity strength received from the circuitry; and
converting the resonance frequency into temperature to measure a temperature of an object to be measured.

9. The wireless measuring apparatus according to claim 2,
wherein the sensor unit has a circuit having a piezo-resonator connected to a coil in parallel.

10. The wireless measuring apparatus according to claim 2, wherein:
the sensor unit is a temperature sensor including a piezo-resonator that an oscillation frequency is changed depending on temperature; and
the measuring means has a means configured to measure a resonance frequency from the oscillation frequency of the piezo-resonator changed depending on temperature and convert the resonance frequency into temperature to measure a temperature of an object to be measured.

11. The wireless measuring apparatus according to claim 3, wherein:
the sensor unit is a temperature sensor including a piezo-resonator that an oscillation frequency is changed depending on temperature; and
the measuring means has a means configured to measure a resonance frequency from the oscillation frequency of the piezo-resonator changed depending on temperature and convert the resonance frequency into temperature to measure a temperature of an object to be measured.

12. The wireless measurement system according to claim 6, wherein the sensor unit has a circuit having a piezo-resonator connected to a coil in parallel.

11. The wireless measuring apparatus according to claim 9, wherein:
the sensor unit is a temperature sensor including a piezo-resonator that an oscillation frequency is changed depending on temperature; and
the measuring means has a means configured to measure a resonance frequency from the oscillation frequency of the piezo-resonator changed depending on temperature and convert the resonance frequency into temperature to measure a temperature of an object to be measured.
